(19) United States
(12) Patent Application Publication
(10) Pub. No.: US 2009/0040233 A1
(43) Pub. Date: Feb. 12, 2009

(54) Wearable Type Information Presentation Device

(76) Inventor: Kakuya Yamamoto, Hyogo (JP)

Correspondence Address: WENDEROTH, LIND & PONACK L.L.P., 2033 K. STREET, NW, SUITE 800, WASHINGTON, DC, 20006, US

(21) Appl. No.: 10/592,425

(22) PCT Filed: Jun. 7, 2005
(86) PCT No.: PCT/JP2005/010423

§ 371 Date: Sep. 11, 2006

(30) Foreign Application Priority Data
Jun. 10, 2004 (JP) 2004-172135

(51) Int. Cl. G09G 5/30; G05B 23/02

(52) U.S. Cl. 345/592; 340/3.1

(57) ABSTRACT

An object of the present invention is to provide a wearable type information presentation device that allows a user to perform both an activity and information viewing/hearing while taking into consideration the safety of the user.

The wearable type information presentation device according to the present invention includes: a situation acquisition unit (101), which acquires a situation of the user; a viewing/hearing adaptability storage unit (106), which stores a viewing/hearing adaptability; a viewing/hearing adaptability determination unit (105), which determines the viewing/hearing adaptability that corresponds to the situation of the user; a presentation method determination unit (103), which determines a method in which to present the information to the user, based on the viewing/hearing adaptability; and a presentation unit (104), which presents the information to the user in the determined presentation method.

### TECHNICAL FIELD

The present invention relates to a device that presents information to a user in a state where the device is worn on a part of the user's body.

### BACKGROUND ART

In recent years, information presentation devices called Head Mounted Displays (HMDs), which are in the form of a helmet or goggles, continue to spread. When an HMD is worn on the head area, an image is presented directly in front of the right and left eyes, respectively. By causing the right and left images to differ slightly, it is possible to create a sense of stereoscopic vision. Information presented to a user is not limited to still images; it is possible to present video, such as a television program, and text to a user.

HMDs can be roughly divided into two categories. One is a closed-view HMD which blocks light incoming from outside scene and presents only a virtual image to the user. The other is a transparent-type HMD which presents the virtual image to the user along with a natural image of the incoming light from the outside scene.

With a transparent type HMD, it is possible to view/hear the information while carrying out an activity (such as walking). However, there are instances in which the reciprocal influence of the outside scene and information presented to the user (hereafter referred to as “presented information”) make it difficult to view/hear the presented information.

For example, it is difficult to view/hear the presented information in the case where a color of the presented information is similar to a color of a part of the outside scene that overlaps with this presented information. Accordingly, an HMD which controls the color of the presented information in accordance with the color of the outside scene is provided (for example, Patent Reference 1). In this conventional HMD, the color of the surrounding area is detected with a camera that monitors the outside scene. The HMD determines whether or not the color of the presented information is similar to the color of the part of the outside scene that overlaps with this presented information, and in the case where the colors are similar, changes the color of the presented information. In this manner, it is possible to present the information to the user in a color that is not similar to the color of the outside scene, and thus the problem in which the presented information is difficult to view due to the outside scene does not arise.

However, there is a problem with this conventional HMD in that when carrying out an activity such as walking while viewing/hearing a television program, the user is immersed in viewing/hearing the television program, which interferes with the activity. Accordingly, in recent years, an HMD which presents information only when the safety of the user can be guaranteed, such as when in a stopped state, is provided (for example, Patent Reference 2).

### Patent Reference 1: Japanese Laid-Open Patent Application No. 9-101477

### Patent Reference 2: Japanese Patent No. 3492942

### DISCLOSURE OF INVENTION

Problems that Invention is to Solve

However, there is a problem with the HMD disclosed in Patent Reference 2 in that the information is presented only when the safety of the user is guaranteed, and thus the activity and the information viewing/hearing cannot be carried out together. In other words, there are cases where a certain amount of information viewing/hearing will not impair the safety of the user, even when not in a stopped state; in such cases, presenting a moderate amount of information is preferable.

An object of the present invention is to solve the aforementioned problems by providing a wearable type information presentation device which allows compatibility of activity and information viewing/hearing while taking into consideration the safety of the user.

### Means to Solve the Problems

To achieve the aforementioned object, a wearable type information presentation device according to the present invention presents information to a user while being worn on a part of the body of the user, and includes: a situation acquisition unit which acquires a situation of the user; a viewing/hearing adaptability storage unit which stores viewing/hearing adaptabilities that indicate a degree to which the user adapts to viewing/hearing the information; a viewing/hearing adaptability determination unit which determines, from among the viewing/hearing adaptabilities stored in the viewing/hearing adaptability storage unit, a viewing/hearing adaptability that corresponds to the situation of the user acquired by the situation acquisition unit; a presentation method determination unit which determines a method for presenting the information to the user, based on the viewing/hearing adaptability determined by the viewing/hearing adaptability determination unit; and a presentation unit which presents the information to the user in the presentation method determined by the presentation method determination unit. Through this, the information is presented to the user in a presentation method that corresponds to the viewing/hearing adaptability, and thus it is possible to carry out an activity and information viewing/hearing together while taking the safety of the user into consideration.

Here, the wearable type information presentation device may further include a fluctuation judgment unit which judges a fluctuation in the viewing/hearing adaptability, and the presentation method determination unit may determine the presentation method based on the fluctuation in the viewing/hearing adaptability. Through this, the fluctuation in the viewing/hearing adaptability is judged, and thus an appropriate presentation method is determined in accordance with the situation of the user which fluctuates over time.

In addition, the presentation method determination unit may determine a presentation method which causes the size of the information presented by said presentation unit to decrease in the case where the viewing/hearing adaptability has decreased, and may determine a presentation method which causes the size of the information presented by said presentation unit to increase in the case where the viewing/hearing adaptability has increased. Through this, an actual presentation area is adjusted appropriately against a presentable area in the presentation unit, and therefore it is possible to pay attention to the presented information and the outside scene as required.

The presentation method determination unit may determine a presentation method in which a position of the information presented by said presentation unit moves away from the center in the case where the viewing/hearing adaptability has decreased, and may determine a presentation method in which the position of the information presented by said presentation unit approaches the center in the case where the viewing/hearing adaptability has increased. Through this, presentation in the center area of the presentation unit, which is easy for the user to concentrate on, is controlled, and therefore it is possible to pay attention to the presented information and the outside scene as required.

The presentation method determination unit may determine a presentation method which increases the display transparency of the information presented by said presentation unit in the case where the viewing/hearing adaptability has decreased, and may determine a presentation method which decreases the display transparency of the information presented by said presentation unit in the case where the viewing/hearing adaptability has increased. Through this, it is possible to pay attention to the outside scene that is overlapped with the presented information as the display transparency increases.

The presentation method determination unit may determine a presentation method in which reproduction of the information presented by said presentation unit is suspended in the case where the viewing/hearing adaptability has decreased, and may determine a presentation method in which reproduction of the information presented by said presentation unit is resumed in the case where the viewing/hearing adaptability has increased. Through this, reproduction is suspended appropriately, and thus it is possible to pay attention to the outside scene. Also, reproduction is resumed appropriately, so problems such as being unable to follow content of the presented information while paying attention to the outside scene, and having to rewind the presented information to follow the content, do not arise.

The viewing/hearing adaptability determination unit may decrease the viewing/hearing adaptability in the case where a fluctuation amount of a visual field image of the user has increased, and may increase the viewing/hearing adaptability in the case where the fluctuation amount of the visual field image of the user has decreased. Through this, it is possible to pay attention to the outside scene when a situation immediately in front of the user has changed significantly.

The viewing/hearing adaptability determination unit may decrease the viewing/hearing adaptability in the case where a fluctuation amount of a bodily movement of the user has increased, and may increase the viewing/hearing adaptability in the case where the fluctuation amount of the bodily movement of the user has decreased. Through this, it is possible to pay attention to the outside scene when the user has begun or finished an activity.

The viewing/hearing adaptability determination unit may decrease the viewing/hearing adaptability in the case where an activity range of the user has changed. Through this, it is possible to pay attention to the outside scene when the activity range of the user has changed, such as when getting on and off a train.

Note that the present invention can be realized not only as this wearable type information presentation device, but can also be realized as a wearable information presentation method which makes steps of the characteristic units included in this wearable type information presentation device, and as a program that causes a computer to execute those steps. In addition, it goes without saying that such a program can be distributed via a storage medium such as a CD-ROM, a transmission medium such as the internet, and so on.

In addition, each function block of the configuration diagram (FIG. 3) is typically realized as an LSI, which is an integrated circuit. These may be realized as individual chips, and may be realized as a chip that includes all or part of the function blocks. Here, LSI is mentioned, but there are instances where, due to a difference in a degree of integration, the designations IC, system LSI, super LSI, and ultra LSI are used.

In addition, the means for realizing an integrated circuit is not limited to LSI, and may be realized as a dedicated circuit or a generic processor. It is also acceptable to use a Field Programmable Gate Array (FPGA) that is programmable after the LSI has been manufactured, a reconfigurable processor in which connections and settings of circuit cells within the LSI are reconfigurable, and so on.

Furthermore, should integrated circuit technology that replaces LSI appear through progress in semiconductor technology or other derived technology, that technology can naturally be used to carry out integration of the function blocks. Application of biotechnology is also a possibility.

### Effects of the Invention

As has been made clear by the above descriptions, the wearable type information presentation device according to the present invention makes it possible to perform an activity and information viewing/hearing together while taking into consideration the safety of the user. Moreover, an appropriate presentation method is determined in accordance with the situation of the user which fluctuates over time.

### BRIEF DESCRIPTION OF DRAWINGS

FIG. 1 is a diagram showing a state in which a user is wearing an HMD according to the present invention.

FIG. 2 is a diagram showing a state in which a user is wearing a different HMD according to the present invention.

FIG. 3 is a configuration diagram showing a wearable type information presentation device according to the present invention.

FIG. 4 is a diagram showing an association table for a user situation and a viewing/hearing adaptability.

FIG. 5 is a flowchart of the wearable type information presentation device according to the present invention.

FIG. 6 is a flowchart of the wearable type information presentation device according to the present invention.

FIG. 7 is a flowchart of the wearable type information presentation device according to the present invention.

FIG. 8 is a flowchart of the wearable type information presentation device according to the present invention.

FIG. 9 is a flowchart of the wearable type information presentation device according to the present invention.

FIGS. 10A and 10B are diagrams showing a fluctuation in a visual field image of the user.

FIGS. 11A and 11B are diagrams showing a fluctuation in a visual field image of the user.

FIG. 12 is a flowchart of the wearable type information presentation device according to the present invention.

FIG. 13 is a flowchart of the wearable type information presentation device according to the present invention.

FIG. 14A is a diagram showing an example of presentation for the user while walking, and FIG. 14B is a diagram showing an example of presentation for the user while in a train.

### NUMERICAL REFERENCES

101 situation acquisition unit

102 fluctuation judgment unit

103 presentation method determination unit

104 presentation unit

105 viewing/hearing adaptability determination unit

106 viewing/hearing adaptability storage unit

### BEST MODE FOR CARRYING OUT THE INVENTION

Embodiments of the present invention are hereafter described with reference to the diagrams.

### FIRST EMBODIMENT

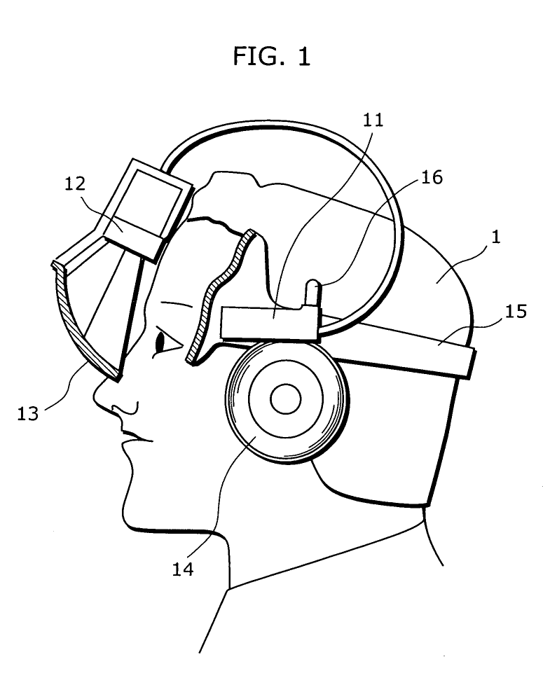

FIG. 1 is a diagram showing a state in which a user is wearing a Head Mounted Display (HMD) according to the present invention. This HMD is a wearable type information presentation device such as goggles, a helmet, or the like, and includes: a calculator 11, which executes each kind of control in order to present information to the user; a display device 12, such as a Liquid Crystal Display (LCD); an optical element (presentation screen) 13, which is placed in front of the eyes of the user; a headphone 14 for audio information; a carrying unit 15, for mounting the HMD onto a head area of a user 1; and a receiving device 16 for receiving presentation information from the Internet and so on.

One surface of the optical element 13 is a concave aspheric surface with a half-transparent mirror film applied on the surface, which reflects information displayed by the display unit 12, forming a virtual image. The other surface of the optical element 13 is a convex aspheric surface, which allows an outside scene to be viewed. Therefore, the user can view the information displayed by the display unit 12 overlapped with the outside scene.

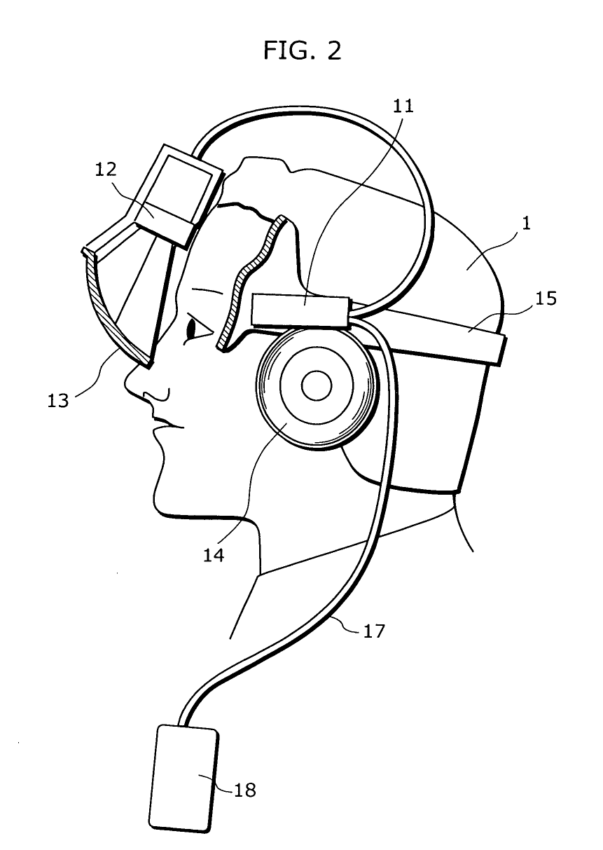

FIG. 2 is a diagram showing a state in which a user is wearing a different HMD according to the present invention. This HMD includes a storage unit 18, which has the presented information pre-stored, and a cable 17, which connects the storage unit 18 with the calculator 11, in place of the receiving device 16 shown in FIG. 1. It is acceptable for the storage unit 18 to be realized as a personal computer, and it is also acceptable for this personal computer to be connected to a Local Area Network (LAN), the Internet, and so on.

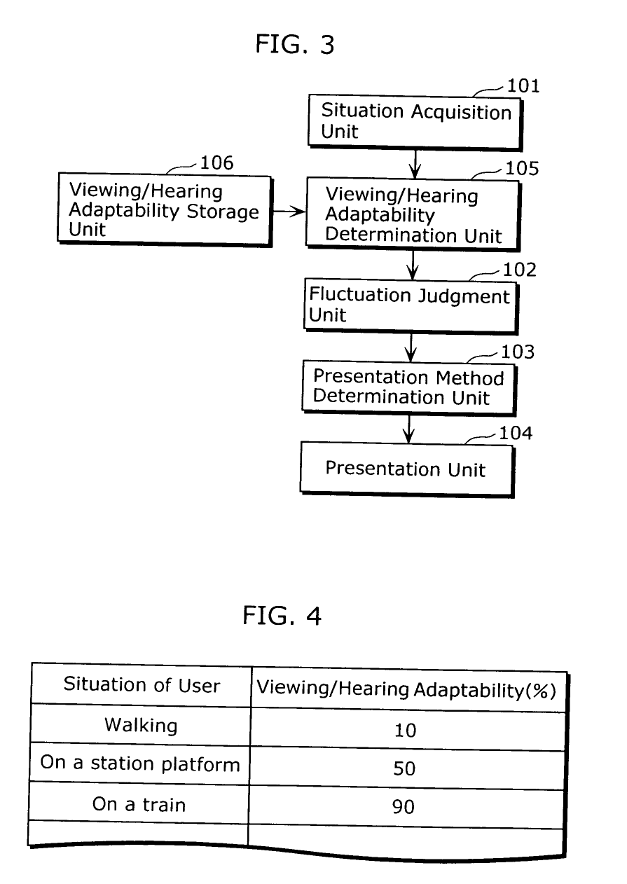

FIG. 3 is a configuration diagram showing a wearable type information presentation device according to the present invention. This wearable type information presentation device is a device that presents information to a user while in a state in which the device is mounted on a part of the body of the user, and functionally includes: a situation acquisition unit 101; a viewing/hearing adaptability storage unit 106; a viewing/hearing adaptability determination unit 105; a fluctuation judgment unit 102; a presentation method determination unit 103; and a presentation unit 104.

The situation acquisition unit 101 is a camera, a Global Positioning System (GPS), an acceleration sensor, a slope sensor, a magnetic sensor, a tag sensor, and the like that acquires the situation of the user. A visual field image, bodily movement, activity plan, and current position of the user are included in the situation of the user.

The viewing/hearing adaptability storage unit 106 stores a viewing/hearing adaptability. Viewing/hearing adaptability refers to information indicating a degree to which the user is adapted to viewing/hearing the presented information. Here, the viewing/hearing adaptability is expressed as a percentage, and the higher the value, the more the user is adapted to viewing/hearing the presented information.

The viewing/hearing adaptability determination unit 105 determines the viewing/hearing adaptability. For example, as shown in FIG. 4, it is assumed that an association table for the situation of the user and the viewing/hearing adaptability is stored in the viewing/hearing adaptability storage unit 106. In this case, when information indicating that the user is walking is acquired through the situation acquisition unit 101, the viewing/hearing adaptability is determined to be 10%. The method for determining the viewing/hearing adaptability is not limited to this, and another determination method may be employed; this is described later.

The fluctuation judgment unit 102 judges a fluctuation in the viewing/hearing adaptability. For example, in the case where the viewing/hearing adaptability fluctuates from 10% to 50%, the viewing/hearing adaptability is judged to have increased. Conversely, in the case where the viewing/hearing adaptability fluctuates from 50% to 10%, the viewing/hearing adaptability is judged to have decreased.

The presentation method determination unit 103 determines a method in which to present information to the user based on the determination results of the fluctuation judgment unit 102. This presentation method includes a change method of a display size of the presented information, a display position, a display transparency, and a reproduction state.

The presentation unit 104 presents the information to the user based on the presentation method determined by the presentation method determination unit 103. This presented information includes moving pictures with audio, such as a television program acquired through communications, broadcast, and the like, and text, still images, moving pictures, signals, and so on acquired from a server on the Internet or a home server in the user's own home.

Depending on the configuration, the information is presented to the user in the presentation method that corresponds to the viewing/hearing adaptability. Therefore, it is possible for an activity and information viewing/hearing to be compatible while taking into consideration the safety of the user. In addition, the fluctuation in the viewing/hearing adaptability is judged, and therefore an appropriate presentation method is determined according to the situation of the user, which fluctuates as time passes.

Note that the situation acquisition unit 101 may acquire the situation of the user via a network. For example, an activity plan of the user may be acquired from a server on the Internet.

Note that the viewing/hearing adaptability determination unit 105 may, in determining the viewing/hearing adaptability, use information aside from the situation of the user. For example, a history of past situations, a situation of another person, an adaptability determination rule prepared in advance, and so on, may be used.

Note that the presentation method determination unit 103 may, in determining the presentation method, use information aside from the viewing/hearing adaptability. For example, a history of past presentation methods, a presentation method of another person, a presentation method determination rule prepared in advance, and so on, may be used.

Note that there are various specific specifications for the presentation unit 104, and the presentation unit 104 is not particularly limited. For example, a head mounted display, a face mounted display, an eyeglasses type display, a transparent type display, a retinal projection display, an information display unit of a cellular phone, a portable television, a mobile terminal, and so on, may be employed as the presentation unit 104.

Note that each unit in FIG. 3 may or may not be in a single computer. For example, it is acceptable for the situation acquisition unit 101 and the presentation unit 104 to be in separate machines, and the presentation method determination unit 103 may be in a server on the Internet. In addition, each unit may be dispersed throughout a plurality of computers. In addition, a plurality of each unit in FIG. 3 may exist. For example, there may be two presentation units 104. Each user may share each unit in FIG. 3.

Note that an HMD is shown as an example here, but the position in which the wearable type information presentation device according to the present invention is worn is not limited to the head area. That is, as long as the device can present information to the user in a state where the device is worn on a part of the body of the user, the device is applicable to the present invention.

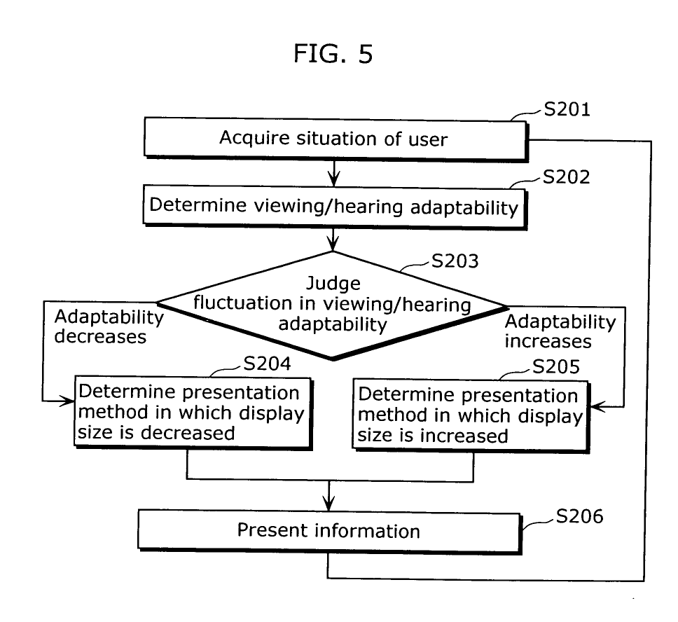

FIG. 5 is a flowchart of the wearable type information presentation device according to the present invention. Here, a scene is assumed in which the user wears a transparent type HMD and views/hears a television program while commuting, and an operation, in which a display size of the television program in the presentation unit 104 changes in accordance with that situation, is described.

The situation acquisition unit 101 acquires the situation of the user (S201).

The viewing/hearing adaptability determination unit 105 determines the viewing/hearing adaptability based on the situation of the user acquired through the situation acquisition unit 101 (S202).

The fluctuation judgment unit 102 judges the fluctuation in the viewing/hearing adaptability based on the viewing/hearing adaptability determined by the viewing/hearing adaptability determination unit 105 (S203).

The presentation method determination unit 103 determines a presentation method that causes the display size to be reduced in the case where the viewing/hearing adaptability has decreased (S204), or determines a presentation method that causes the display size to be enlarged in the case where the viewing/hearing adaptability has increased (S205).

The presentation unit 104 presents the television program through the presentation method determined by the presentation method determination unit 103 (S206).

By repeating the above operation (S201 to S206), an appropriate presentation method is determined in accordance with the situation of the user which changes as time passes. That is, an actual display area is appropriately adjusted to the displayable area of the presentation unit 104. Therefore, the user can pay attention to the presented information and the outside scene as necessary.

Note that the operation for reducing the display size includes an operation in which the display size is 0 and the information is not displayed.

Note that the process of the change in the display size can be displayed as an animation, in accordance with the change in the display size.

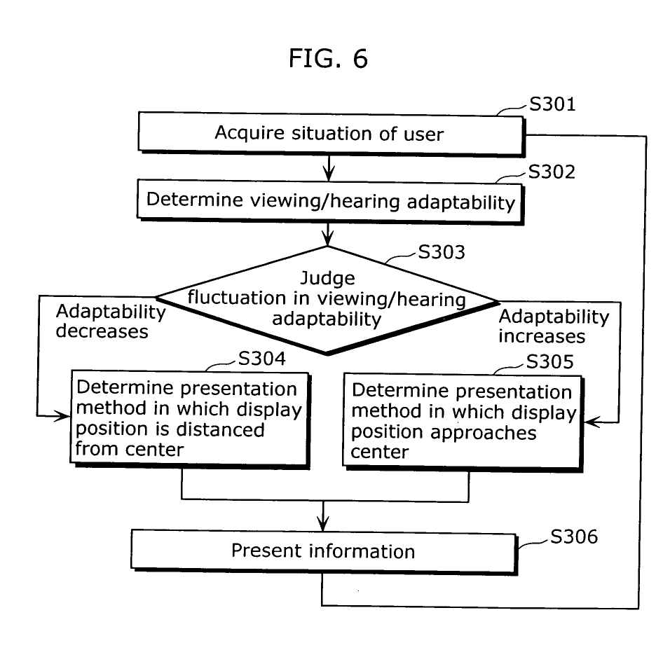

FIG. 6 is a flowchart of the wearable type information presentation device according to the present invention. Here, a process in which a display position of the television program changes in the presentation unit 104 is described.

The situation acquisition unit 101 acquires the situation of the user (S301).

The viewing/hearing adaptability determination unit 105 determines the viewing/hearing adaptability based on the situation of the user acquired by the situation acquisition unit 101 (S302).

The fluctuation judgment unit 102 judges the fluctuation in the viewing/hearing adaptability based on the viewing/hearing adaptability determined by the viewing/hearing adaptability determination unit 105 (S303).

The presentation method determination unit 103 determines a presentation method that causes the display position to move away from the center in the case where the viewing/hearing adaptability has decreased (S304), or determines a presentation method that causes the display position to approach the center in the case where the viewing/hearing adaptability has increased (S305).

The presentation unit 104 presents the television program through the presentation method determined by the presentation method determination unit 103 (S306).

By repeating the above operation (S301 to S306), an appropriate presentation method is determined in accordance with the situation of the user which changes as time passes. That is, the presentation in the central area of the presentation unit 104, which is easy for the user to concentrate on, is controlled. Therefore, the user can pay attention to the presented information and the outside scene as necessary.

Note that the operation in which the display position moves away from the center includes an operation in which the display position moves away from the center and the information is not displayed.

Note that the aforementioned “center of the display position” may be the center of the information presentation region of the presentation unit 104, and may be the center of the visual field of the user, and may be a region corresponding to the movement direction of the user during movement.

Note that the process of the change in the display position can be displayed as an animation, in accordance with the change in the display position.

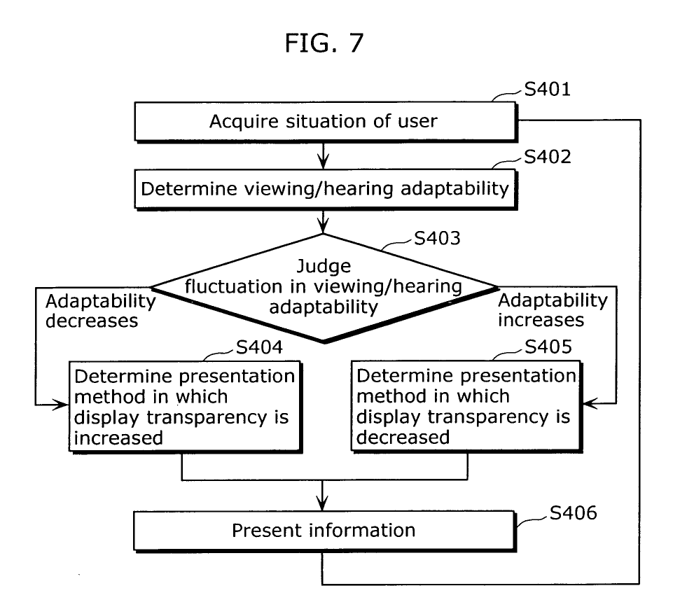

FIG. 7 is a flowchart of the wearable type information presentation device according to the present invention. Here, an operation, in which a degree of transparency of the television program is changed in the presentation unit 104, is described.

The situation acquisition unit 101 acquires the situation of the user (S401).

The viewing/hearing adaptability determination unit 105 determines the viewing/hearing adaptability based on the situation of the user acquired through the situation acquisition unit 101 (S402).

The fluctuation judgment unit 102 judges the fluctuation in the viewing/hearing adaptability based on the viewing/hearing adaptability determined by the viewing/hearing adaptability determination unit 105 (S403).

The presentation method determination unit 103 determines a more transparent presentation method which causes the display transparency to be increased in the case where the viewing/hearing adaptability has decreased (S404), or determines a less transparent presentation method that causes the display transparency to be decreased in the case where the viewing/hearing adaptability has increased (S405).

The presentation unit 104 presents the television program through the presentation method determined by the presentation method determination unit 103 (S406).

By repeating the above operation (S401 to S406), an appropriate presentation method is determined in accordance with the situation of the user which changes as time passes. In other words, by increasing the degree of display transparency, it becomes possible to pay attention to the outside scene which overlaps with the presented information.

Note that the area in which the degree of display transparency is changed may be all or part of the presented information. The display transparency may differ depending on the part of the presented information, and the method for changing the display transparency may differ depending on the part of the presented information.

Note that the operation of increasing the degree of display transparency includes an operation in which the display transparency is 100% and the information is not displayed.

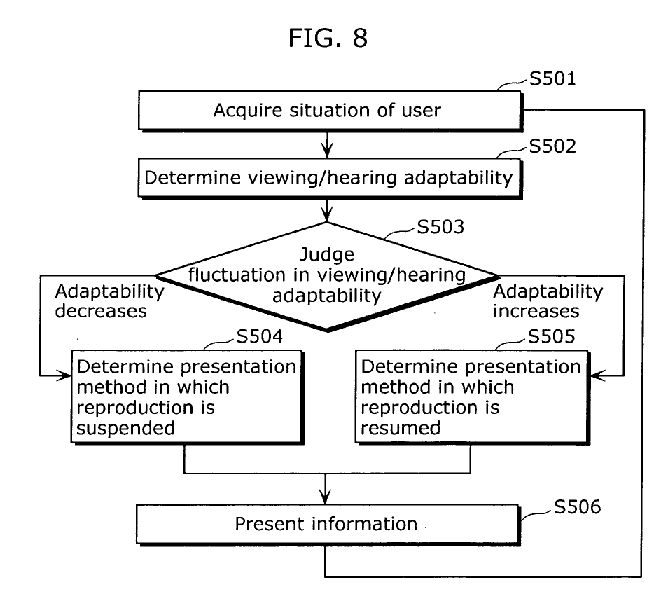

FIG. 8 is a flowchart of the wearable type information presentation device according to the present invention. Here, an operation, in which the reproduction state of the television program is changed in the presentation unit 104, is described.

The situation acquisition unit 101 acquires the situation of the user (S501).

The viewing/hearing adaptability determination unit 105 determines the viewing/hearing adaptability based on the situation of the user acquired by the situation acquisition unit 101 (S502).

The fluctuation judgment unit 102 judges the fluctuation in the viewing/hearing adaptability based on the viewing/hearing adaptability determined by the viewing/hearing adaptability determination unit 105 (S503).

The presentation method determination unit 103 determines a presentation method in which reproduction of the presented information is suspended in the case where the viewing/hearing adaptability has decreased (S504), or determines a presentation method in which reproduction of the presented information is resumed in the case where the viewing/hearing adaptability has increased (S505).

The presentation unit 104 presents the television program through the presentation method determined by the presentation method determination unit 103 (S506).

By repeating the above operation (S501 to S506), an appropriate presentation method is determined in accordance with the situation of the user which changes as time passes. That is, reproduction is suspended at an appropriate time, and therefore it is possible to pay attention to the outside scene. In addition, reproduction is resumed at an appropriate time, and therefore a problem in which the content of the presented information cannot be followed while paying attention to the outside scene, and a problem in which the presented information must be rewound, do not arise.

Note that the operation in which reproduction is suspended includes an operation in which reproduction is completely suspended, an operation in which reproduction speed is slowed, an operation in which a frame rate during moving picture reproduction is reduced, and an operation in which digest reproduction, which reproduces only the main segments, is carried out.

In such a manner, the present invention employs a variety of presentation methods.

Incidentally, in the aforementioned descriptions, it is assumed that, as shown in FIG. 4, the viewing/hearing adaptability storage unit 106 stores the association table of the situation of the user and the viewing/hearing adaptability, but the present invention is not limited to this. That is, it is acceptable for the viewing/hearing adaptability to be stored in the viewing/hearing adaptability storage unit 106 in any form, and that form is not particularly limited. Hereafter, a method for determining the viewing/hearing adaptability employed in the present invention is described.

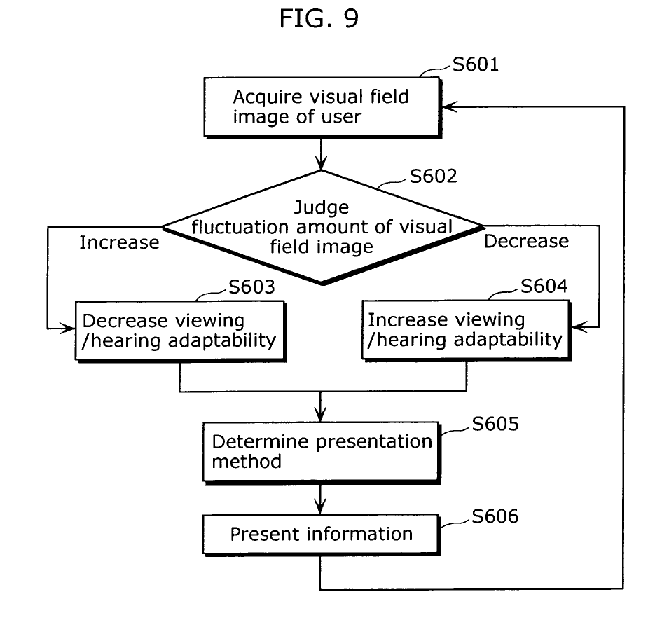

FIG. 9 is a flowchart of the wearable type information presentation device according to the present invention. Here, an operation, in which the viewing/hearing adaptability is changed based on a fluctuation amount in the visual field image of the user (described later), is described.

The situation acquisition unit 101 acquires the visual field image of the user as the situation of the user (S601). The visual field image of the user can be acquired by a camera and the like included in the HMD.

The viewing/hearing adaptability determination unit 105 determines the fluctuation amount of the visual field image of the user acquired by the situation acquisition unit 101 (S602). Then, the viewing/hearing adaptability determination unit 105 decreases the viewing/hearing adaptability in the case where the fluctuation amount of the visual field image of the user has increased (S603), or increases the viewing/hearing adaptability in the case where the fluctuation amount of the visual field image of the user has decreased (S604).

The presentation method determination unit 103 determines the presentation method based on the viewing/hearing adaptability determined by the viewing/hearing adaptability determination unit 105 (S605). This method for determining the presentation method is not particularly limited. That is, it is acceptable to determine the presentation method based on the aforementioned association table (see FIG. 4), or based on the fluctuation of the viewing/hearing adaptability (see FIGS. 5 to 8).

The presentation unit 104 presents the television program in the presentation method determined by the presentation method determination unit 103 (S606).

By repeating the above operation (S601 to S606), an appropriate presentation method is determined in accordance with the situation of the user which changes as time passes. That is, when the state in front of the eyes of the user has changed greatly, it is possible to pay attention to the outside scene.

Here, the fluctuation amount of the visual field image of the user is described.

While a method for calculating the fluctuation amount of the visual field image of the user is not particularly limited, it is possible, for example, to employ a method which focuses on a movement amount of an object within the visual field image of the user.

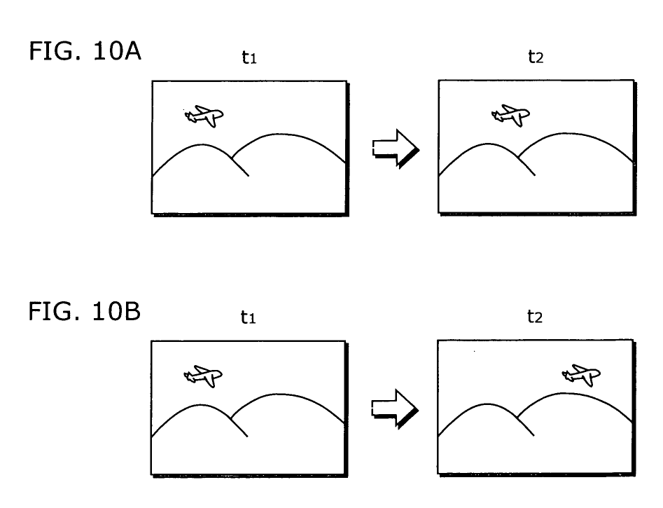

FIGS. 10A and 10B are diagrams showing a fluctuation in a visual field image of the user. Here, an airplane is shown moving from time t1 to time t2. In this case, the movement amount of the object shown in FIG. 10B (the movement amount of the airplane) is greater than the movement amount of the object shown in FIG. 10A (the movement amount of the airplane).

Accordingly, the viewing/hearing adaptability determination unit 105 determines an increase/decrease in the movement amount of the object, and determines the viewing/hearing adaptability based on that determination result (S603, S604). A guideline value is of course important for determining the increase/decrease in the movement amount of the object. This guideline value is not particularly limited, but it is possible, for example, to employ the movement amount of the object from time t0 to time t1. Note that time t0 refers to a time one unit previous to the time t1.

The method for calculating the fluctuation volume of the visual field of the user is not limited to this. As another method, it is possible to employ a method that focuses on the area of the region within the visual field of the user in which fluctuation occurred (referred to as “fluctuation region”).

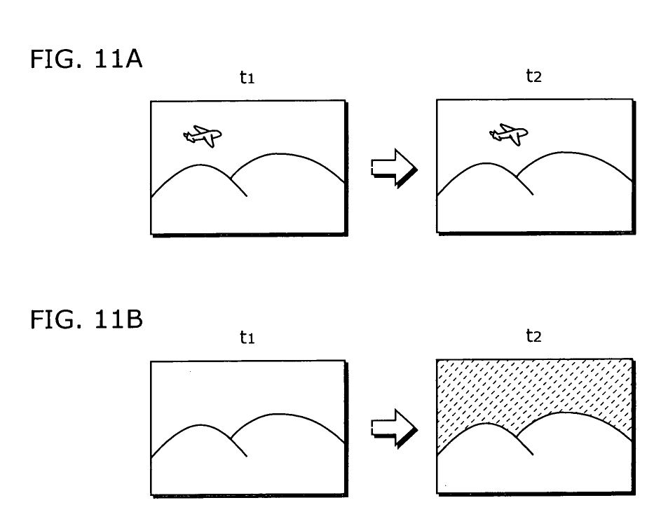

FIGS. 11A and 11B are diagrams showing a fluctuation in a visual field image of the user. In this case, the area of the fluctuation region shown in FIG. 11B (the area of the empty part) is greater than the area of the fluctuation region shown in FIG. 11A (the area of the airplane part).

Accordingly, the viewing/hearing adaptability determination unit 105 determines an increase/decrease in the area of the fluctuation region, and determines the viewing/hearing adaptability based on that determination result (S603, S604). A guideline value is of course important for determining the increase/decrease in the area of the fluctuation region. This guideline value is similar to the aforementioned guideline value in that it is possible to employ the area of the fluctuation region from time t0 to time t1.

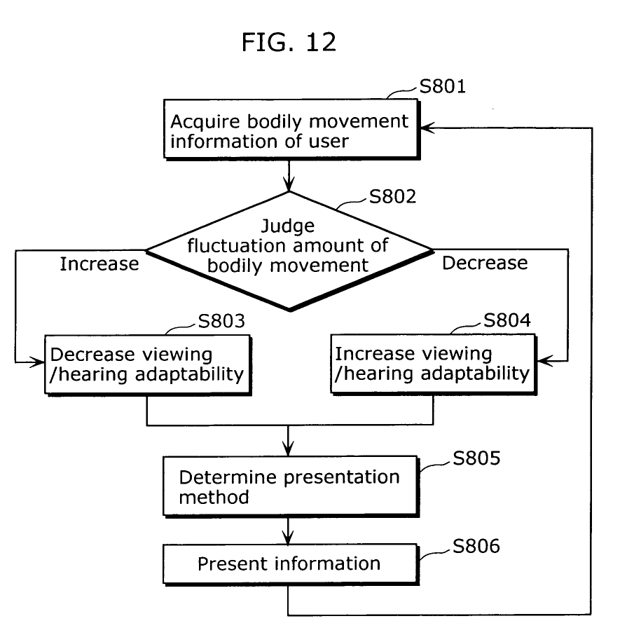

FIG. 12 is a flowchart of the wearable type information presentation device according to the present invention. Here, an operation, in which the viewing/hearing adaptability is caused to change based on a fluctuation amount of a bodily movement of the user, is described.

The situation acquisition unit 101 acquires the bodily movement of the user as the situation of the user (S801). The bodily movement of the user can be acquired through various types of sensors and the like included in the HMD.

The viewing/hearing adaptability determination unit 105 determines the fluctuation amount of the bodily movement of the user acquired by the situation acquisition unit 101 (S802). Then, the viewing/hearing adaptability determination unit 105 decreases the viewing/hearing adaptability in the case where the fluctuation amount of the bodily movement of the user has increased (S803), or increases the viewing/hearing adaptability in the case where the fluctuation amount of the bodily movement of the user has decreased (S804).

The presentation method determination unit 103 determines the presentation method based on the viewing/hearing adaptability determined by the viewing/hearing adaptability determination unit 105 (S805). This method for determining the presentation method is not particularly limited.

The presentation unit 104 presents the television program in the presentation method determined by the presentation method determination unit 103 (S806).

By repeating the above operation (S801 to S806), an appropriate presentation method is determined in accordance with the situation of the user which changes as time passes. That is, it is possible to pay attention to the outside scene when the user starts or finishes an activity.

Note that the bodily movement includes speed, direction, and change in speed of walking and running; direction and movement of the neck; movement and direction of the eyes and the line of vision; movement and change thereof in the wrists and fingers; geographical location and fluctuation therein; and activity patterns such as pulse, breathing, body temperature, sweat, voice, gestures, sitting down, walking, and so on.

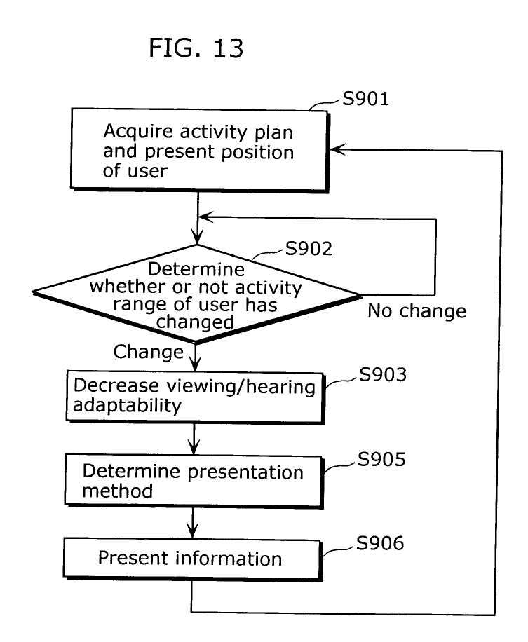

FIG. 13 is a flowchart of the wearable type information presentation device according to the present invention. Here, an operation, in which the viewing/hearing adaptability is caused to change based on a fluctuation in the activity range of the user, is described.

The situation acquisition unit 101 acquires an activity plan of the user and a current position of the user as the situation of the user (S901). It is possible to acquire the activity plan of the user from a server and the like on the Internet, and it is possible to acquire the current position of the user through a GPS and the like included in the HMD.

The viewing/hearing adaptability determination unit 105 determines whether or not the activity range of the user has changed based on the activity plan of the user and the current position of the user acquired from the situation acquisition unit 101 (S902). Then, in the case where the activity range of the user has changed, the viewing/hearing adaptability is caused to decrease (S903). In the case where the activity range of the user has not changed, no special processing is carried out. Note that the activity range of the user refers to a range in which the situation of the user is not assumed to change significantly, such as inside a train, indoors, outdoors, and so on.

The presentation method determination unit 103 determines the presentation method based on the viewing/hearing adaptability determined by the viewing/hearing adaptability determination unit 105 (S905). This method for determining the presentation method is not particularly limited.

The presentation unit 104 presents the television program in the presentation method determined by the presentation method determination unit 103 (S906).

By repeating the above operation (S901 to S906), an appropriate presentation method is determined in accordance with the situation of the user which changes as time passes. That is, it is possible for the user to pay attention to the outside scene when the activity range of the user has changed, such as when boarding/exiting a train.

Note that the activity plan may include a movement process such as changing trains, boarding a train, and walking, and furthermore, may include targets representing intermediate points such as a beginning of a staircase, and ending of a staircase, a corner, a ticket gate, a crosswalk, a pedestrian bridge, a shop, and so on.

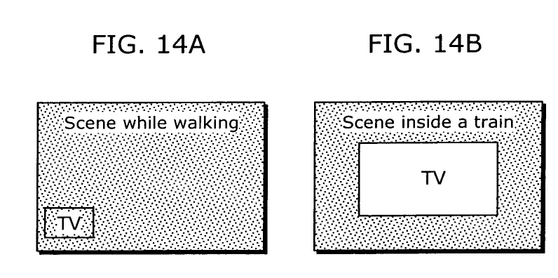

FIG. 14A is a diagram showing an example of presentation for the user while walking, and FIG. 14B is a diagram showing an example of presentation for the user while in a train. Here, the case in which aforementioned presentation methods are combined is described.

In the case where the user is walking, the television screen is displayed at half-transparency, in a small size in the lower-left corner, overlapped onto the outside scene, as shown in FIG. 14A. On the other hand, in the case where the user is in a train, the television screen is shown non-transparently, in a large size in the center, overlapped onto the outside scene, as shown in FIG. 14B.

In other words, because the fluctuation amount of the visual field image increases during walking as compared to while on the train, and the fluctuation amount of the bodily movement increases, the viewing/hearing adaptability is reduced. As a result, the television program is presented with the display size of the television screen reduced, the display position distanced from the center, and the display transparency increased.

Note that the time from when the viewing/hearing adaptability determination unit 105 determines the viewing/hearing adaptability to when the presentation method determination unit 103 determines the presentation method may be instantaneous, or may take a certain amount of time. In addition, the time from when the presentation method determination unit 103 determines the presentation method to when the presentation unit 104 present the information may be instantaneous, or may take a certain amount of time.

Note that “increase” in the present invention includes an increase amount and an increase degree of 0; that is, includes no change in the increase amount and increase degree. Similarly, “decrease” includes a decrease amount and a decrease degree of 0; that is, includes no change in the decrease amount and decrease degree.

Note that it is acceptable to intermittently change the presentation method in the present invention. For example, when decreasing the display size, it is acceptable to re-display at a smaller size than before, after once stopping the display, and it is acceptable to decrease the display size after temporarily increasing the display size. In addition, it is acceptable to temporarily suspend the display in the case where the viewing/hearing adaptability has changed, and resume the display after a set amount of time has passed, or after the change in the viewing/hearing adaptability has stabilized.

### INDUSTRIAL APPLICABILITY

A wearable type information presentation device according to the present invention can be applied to a head mounted display, a face mounted display, an eyeglasses type display, and the like in which it is necessary for activity and information viewing/hearing to be compatible while taking into consideration the safety of a user.

1. A wearable type information presentation device that presents information to a user while being worn on a part of the body of the user, said device comprising:
a situation acquisition unit operable to acquire a situation of the user;
a viewing/hearing adaptability storage unit operable to store viewing/hearing adaptabilities which indicate a degree to which the user adapts to viewing/hearing the information;
a viewing/hearing adaptability determination unit operable to determine, from among the viewing/hearing adaptabilities stored in said viewing/hearing adaptability storage unit, a viewing/hearing adaptability that corresponds to the situation of the user acquired by said situation acquisition unit;
a presentation method determination unit operable to determine a method for presenting the information to the user, based on the viewing/hearing adaptability determined by said viewing/hearing adaptability determination unit; and
a presentation unit operable to present the information to the user in the presentation method determined by said presentation method determination unit.

2. The wearable type information presentation device according to claim 1, further comprising
a fluctuation judgment unit operable to judge a fluctuation in the viewing/hearing adaptability,
wherein said presentation method determination unit is operable to determine the presentation method based on the fluctuation in the viewing/hearing adaptability.

3. The wearable type information presentation device according to claim 2,
wherein said presentation method determination unit is operable to determine a presentation method which causes the size of the information presented by said presentation unit to decrease in the case where the viewing/hearing adaptability has decreased, and is operable to determine a presentation method which causes the size of the information presented by said presentation unit to increase in the case where the viewing/hearing adaptability has increased.

4. The wearable type information presentation device according to claim 2,
wherein said presentation method determination unit is operable to determine a presentation method in which a position of the information presented by said presentation unit moves away from the center in the case where the viewing/hearing adaptability has decreased, and is operable to determine a presentation method in which the position of the information presented by said presentation unit approaches the center in the case where the viewing/hearing adaptability has increased.

5. The wearable type information presentation device according to claim 2,
wherein said presentation method determination unit is operable to determine a presentation method which increases the display transparency of the information presented by said presentation unit in the case where the viewing/hearing adaptability has decreased, and is operable to determine a presentation method which decreases the display transparency of the information presented by said presentation unit in the case where the viewing/hearing adaptability has increased.

6. The wearable type information presentation device according to claim 2,
wherein said presentation method determination unit is operable to determine a presentation method in which reproduction of the information presented by said presentation unit is suspended in the case where the viewing/hearing adaptability has decreased, and is operable to determine a presentation method in which reproduction of the information presented by said presentation unit is resumed in the case where the viewing/hearing adaptability has increased.

7. The wearable type information presentation device according to claim 1,
wherein said viewing/hearing adaptability determination unit is operable to decrease the viewing/hearing adaptability in the case where a fluctuation amount of a visual field image of the user has increased, and is operable to increase the viewing/hearing adaptability in the case where the fluctuation amount of the visual field image of the user has decreased.

8. The wearable type information presentation device according to claim 1,
wherein said viewing/hearing adaptability determination unit is operable to decrease the viewing/hearing adaptability in the case where a fluctuation amount of a bodily movement of the user has increased, and is operable to increase the viewing/hearing adaptability in the case where the fluctuation amount of the bodily movement of the user has decreased.

9. The wearable type information presentation device according to claim 1,
wherein said viewing/hearing adaptability determination unit is operable to decrease the viewing/hearing adaptability in the case where an activity range of the user has changed.

10. An information presentation method of presenting information to a user, said method comprising:
a situation acquisition step of acquiring a situation of the user;
a viewing/hearing adaptability determination step of determining, based on the situation of the user acquired in said situation acquisition step, a viewing/hearing adaptability which indicates a degree to which the user adapts to viewing/hearing the information;
a presentation method determination step of determining, based on the viewing/hearing adaptability determined in said viewing/hearing adaptability determination step, a method for presenting the information to the user; and
a presentation step of presenting the information to the user in the presentation method determined in said presentation method determination step.

11. A program for presenting information to a user, said program causing a computer to execute:
a situation acquisition step of acquiring a situation of the user;
a viewing/hearing adaptability determination step of determining, based on the situation of the user acquired in said situation acquisition step, a viewing/hearing adaptability which indicates a degree to which the user adapts to viewing/hearing the information;
a presentation method determination step of determining, based on the viewing/hearing adaptability determined in said viewing/hearing adaptability determination step, a method for presenting the information to the user; and
a presentation step of presenting the information to the user in the presentation method determined in said presentation method determination step.
